(19) United States
(12) Patent Application Publication
(10) Pub. No.: US 2004/0017533 A1
(43) Pub. Date: Jan. 29, 2004

(54) Liquid crystal display

(76) Inventor: Tomonobu Sumino, Tokyo (JP)

Correspondence Address: WILDMAN, HARROLD, ALLEN & DIXON, 225 WEST WACKER DRIVE, CHICAGO, IL, 60606, US

(21) Appl. No.: 10/406,528

(22) Filed: Apr. 3, 2003

(30) Foreign Application Priority Data
Apr. 5, 2002 (JP) 2002-103481

(51) Int. Cl. G02F 1/1343

(52) U.S. Cl. 349/141

(57) ABSTRACT

A liquid crystal display which generation of reverse twist is prevented, capable of displaying an excellent image having a wide visibility angle property, and containing no display irregularity is provided. The liquid crystal display comprises a liquid crystal layer formed by sandwiching a liquid crystal substance in between a color filter substrate and an electrode substrate having a pixel electrode and a common electrode provided parallel to the substrate surface, the color filter substrate has a black matrix, a color filter composed of coloring patterns of a plurality of colors, and a protective layer formed to cover the above-mentioned black matrix and color filter, and the black matrix has an electric conductivity of 9.0×¹⁰⁻⁹ S/cm or less and the coloring pattern has an electric conductivity of 2.0 ×10⁻¹⁰ S/cm or less.

### BACKGROUND OF THE INVENTION

The present invention relates to a liquid crystal display, more particularly to a liquid crystal display of IPS (In-Plane Switching) liquid crystal mode.

Recently, color liquid crystal displays attract to attention as a flat display. As one example of color liquid crystal displays, there are color liquid crystal displays of TFT mode produced by allowing a color filter substrate provided with a black matrix, a color filter composed of a plurality of colors (usually, three primary colors of red (R), green (G) and blue (B)) and a colon electrode, and an electrode substrate provided with a semiconductor driving element such as a thin film transistor (TFT element) and the like, and a pixel electrode to face to each other with a predetermined gap, and injecting a TN (twist nematic) liquid crystal into this gap portion to form a liquid crystal layer. In such color liquid crystal displays, electric field is applied to the liquid crystal layer by the facing electrodes on both substrates, therefore, the direction of electric field applied to the liquid crystal layer is approximately vertical to the interface of the substrates. However, such color liquid crystal displays of TN mode has narrow angle of visibility and causes a problem that when observed from an oblique direction to the display surface, gradation inversion and color change occur, leading to deterioration in image quality.

On the other hand, recently, color liquid crystal displays of IPS (In-Plane Switching) liquid crystal mode attract attention. This is a mode in which by using a pixel electrode composed of a transparent thin film (thickness: 200 to 2000 Å) of indium tin oxide (ITO) and a common electrode are formed in the form of comb teeth parallel to the substrate surface, transverse electric field approximately parallel to the interface of the substrate is applied to a liquid crystal layer, manifesting a so-called wide visibility angle property.

In conventional color liquid crystal displays of IPS liquid crystal mode, transverse electric field is applied to a liquid crystal layer by a pixel electrode and a colon electrode formed in the form of comb teeth as described above. However, when an oblique direction electric field is present, liquid crystal molecules maybe reverse rotated (reverse twist) to the originally predetermined direction. When such-reverse twist occurs, longer time is necessary for alignment of liquid crystal molecules at the interface portion between a region of forward rotation and a region of reverse twist, consequently, response speed decreases and residual images are formed, causing deterioration in image quality.

For reducing generation of such reverse twist, there is a suggestion of defining the material and the specific resistance of a black matrix, focusing the materials constituting a color filter substrate (Japanese Patent Application Laid-Open (JP-A) No. 9-43590). Further, there is a suggestion of improving the electrode structure of an electrode substrate (JP-A No. 2000-19558).

However, in conventional color liquid crystal displays of IPS liquid crystal mode, an effect of preventing generation of reverse twist is still insufficient.

### SUMMARY OF THE INVENTION

The present invention has been accomplished in view of the above-mentioned conditions, and an object thereof is to provide a liquid crystal display which prevents generation of reverse twist and capable of displaying an excellent image having a wide visibility angle property and containing no display unevenness.

To attain such an object, the present invention provides a liquid crystal display comprising a color filter substrate having a black matrix, a color filter composed of coloring patterns of a plurality of colors and a protective layer is formed to cover the said black matrix and color filter, an electrode substrate having a pixel electrode and a common electrode provided parallel to the substrate surface, and a liquid crystal layer formed by sandwiching a liquid crystal substance in between said electrode substrate and said color filter substrate, wherein the black matrix has an electric conductivity of 9.0×10⁻⁹ S/cm or less and the coloring pattern has an electric conductivity of 2.0×10⁻¹ S/cm or less.

As another aspect of the present invention, said black matrix comprises either high resistance carbon black or titanium oxide in a resin component.

In the present invention as described above, by allowing the black matrix and color filter (coloring pattern) constituting the color filter substrate to have low electric conductivity, the transverse electric field approximately parallel to the interface of the substrate formed of a pixel electrode and a common electrode, attains increased stability, being able to prevent reverse twist.

According to the present invention, the black matrix constituting the color filter substrate has an electric conductivity of 9.0×10⁻⁹ S/cm or less and the color filter (coloring pattern) has an electric conductivity of 2.0×10⁻¹⁰ S/cm or less, therefore, a liquid crystal display is obtained in which the transverse electric field approximately parallel to the interface of the substrate formed of a pixel electrode and a common electrode attains increased stability to a large degree, reverse rotation (reverse twist) of liquid crystal molecules is significantly decreased, and an excellent image having a wide visibility angle property and containing no display unevenness can be displayed.

### BRIEF DESCRIPTION OF THE DRAWINGS

FIG. 1 is a cross-sectional view for one pixel showing one embodiment of the liquid crystal display of IPS liquid crystal mode of the present invention.

FIG. 2 is a plan view of an electrode substrate constituting the liquid crystal display shown in FIG. 1, and the longitudinal cross-section on A-A line corresponds to the cross-section of the electrode substrate in FIG. 1.

FIG. 3 is a plan view showing an electrode in the form of comb teeth of the electrode substrate in examples.

### DESCRIPTION OF THE PREFERRED EMBODIMENT

Hereinafter, the preferred embodiment of the present invention will be explained referring to the drawings.

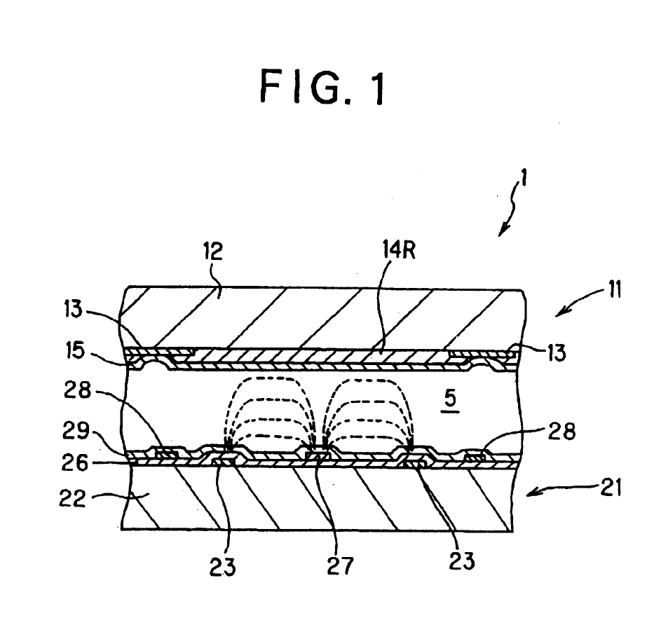

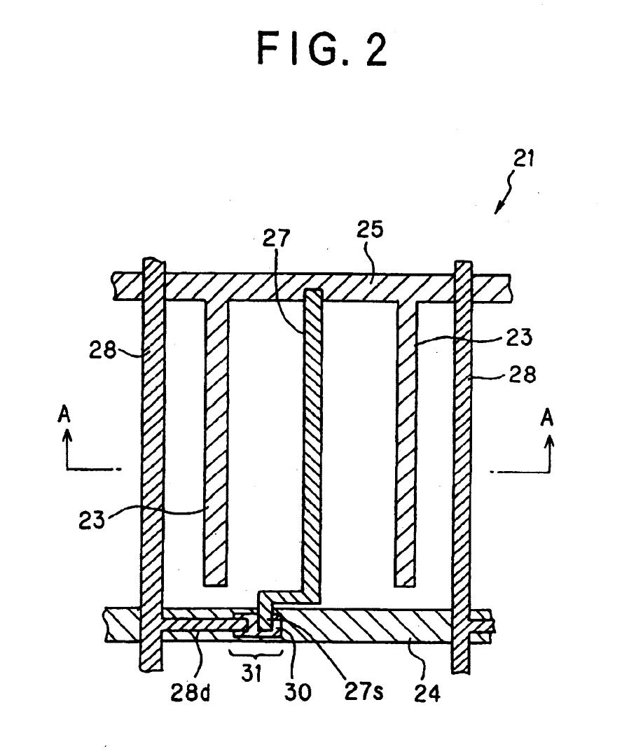

FIG. 1 is a cross-sectional view for one pixel showing one embodiment of the liquid crystal display of IPS liquid crystal mode of the present invention, and FIG. 2 is a plan view of an electrode substrate constituting the liquid crystal display shown in FIG. 1, and the longitudinal cross-section on A-A line corresponds to the cross-section of the electrode substrate in FIG. 1. In FIGS. 1 and 2, in the liquid crystal display 1, a color filter substrate 11 and an electrode substrate 21 are faced at a predetermined interval, and a liquid crystal substance is sandwiched in between both substrates to form a liquid crystal layer 5.

The color filter substrate 11 constituting the liquid crystal display 1 comprises a substrate 12, a black matrix 13 formed so as to comport pixel regions on one surface of this substrate 12, a color filter 14 composed of a red pattern, a green pattern and a blue pattern formed on respective pixel regions (in illustrated example, a red pattern 14R is shown), and a protective layer 15 is formed to cover them. On the opposite side of the color filter formation surface of the substrate 12 of the color filter substrate 11, a polarization plate (not shown in the figure) is provided, and on the protective layer 15, an alignment layer (not shown in the figure) is provided.

On the other hand, an electrode substrate 21 constituting the liquid crystal display 1 comprises a substrate 22; a common electrode 23, scanning wiring 24 and common wiring 25 formed in a predetermined pattern on this substrate 22, a pixel electrode 27 and signal wiring 28 formed in a predetermined pattern via an insulation layer 26, and a protective layer 29 is formed to cover them. On the opposite side of the electrode formation surface of the substrate 22 of the electrode substrate 21, a polarization plate (not shown in the figure) is provided, and on the protective layer 29, an alignment layer (not shown in the figure) is provided.

The above-mentioned common electrode 23 is provided on the substrate surface so as to extend into a pixel region from the common wiring 25, and the pixel electrode 27 is connected to a source electrode of a thin film transistor (TFT) part 31, and extends into a pixel region so as to divide the pixel region approximately in two, and formed parallel to the substrate surface. The width of the above-mentioned common electrode 23 can be set in a range of 2 to 10 μm, the width of the pixel electrode 27 can be set in a range of 2 to 8 μm, and the interval between the common electrode 23 and the pixel electrode 27 can be set in a range of 10 to 30 μm.

A semiconductor active layer 30 made of amorphous silicon a-Si is formed at a predetermined position of the above-mentioned scanning wiring 24, and on this semiconductor active layer 30, a source electrode 27s connected to the pixel electrode 27 and a drain electrode 28d formed extending from the signal wiring 28 are provided at a slight interval, and the thin film transistor (TFT) part 31 is formed. The end of the pixel electrode 27 is superimposed with a common wiring 25 via an insulation layer 26, and forms additional capacity.

In the liquid crystal display of the present invention as described above, the electric conductivity of the black matrix 13 constituting the color filter substrate 11 is 9.0×10⁻⁹ S/cm or less, preferably in a range of 1.0×10⁻¹⁵ to 9.0×10⁻⁹ S/cm, and the electric conductivity of the coloring pattern of each color constituting the color filter 14 is 2.0×10⁻¹⁰ S/cm or less, preferably in a range of 1.0×10⁻¹⁵ to 2.0×10⁻¹⁰ S/cm. Here, the electric conductivity in the present invention is measured according to the following method, and it is different from specific electric conductivity σ which is an inverse number of specific resistance ρ.

(Method of Measuring Electric Conductivity)

On a chromium thin film foxed on a glass substrate, a film is formed in the same process as for formation of a color filter, using a material of measuring subject. On this film, a gold electrode is formed by a vapor deposition method, and electric conductivity is measured between this gold electrode and the above-mentioned chromium thin film using IMPEDANCE/GAIN-PHASE ANALYZER SI1260, DIELECTRIC INTERFACE 1296, manufactured by Solartron. Measurement is conducted at 3V sweeping from 1 Hz to 1 MHz. The measurement result at 1 kHz is used as electric conductivity.

By thus allowing the black matrix 13 and the color filter 14 (coloring pattern) to have low electric conductivity, an influence from the color filter substrate 11 on an electric force line formed in between the common electrode 23 and the pixel electrode 27 can be decreased significantly. As a result, the formed electric field pattern becomes a transverse electric field of stable in approximately parallel direction to the interface of the substrate 22 and can prevent reverse twist of liquid crystal molecules of the liquid crystal layer S. When the electric conductivity of the black matrix 13 is over 9.0×10⁻⁹ S/cm or the electric conductivity of the coloring pattern of each color constituting the color filter 14 is over 2.0×10⁻¹⁰ S/cm, the above-mentioned transverse electric field tends to be influenced by the color filter substrate 11, and it becomes difficult to effectively prevent the reverse twist of liquid crystal molecules.

As the substrates 12, 22 constituting the above-mentioned color filter substrate 11 and electrode substrate 21, transparent rigid materials having no flexibility such as quartz glass, Pyrex (trademark) glass, synthetic quartz and the like, or transparent flexible materials having flexibility such as transparent resin films, optical resin plates and the like can be used. Among them, particularly, 7059 glass manufactured by Corning is a material having small thermal expansion coefficient, excellent in dimension stability and workability in high temperature heating treatment, and is non-alkali glass containing no alkali component in glass, therefore, it is suitable for a color liquid crystal display of IPS liquid crystal mode.

The black matrix 13 constituting the color filter substrate 11 is provided in between pixel regions of the color filter 14 composed of a red pattern, a green pattern and a blue pattern formed in respective pixel regions, and outside of a region of formation of the color filter 14. Such a black matrix 13 can be formed by forming a resin layer containing shading particles and patterning this resin layer, by forming a photosensitive resin layer containing shading particles and patterning this photosensitive resin layer, or by printing in a desired pattern using a resin composition containing shading particles. To make the electric conductivity of the black matrix 13 9.0×10⁻⁹ S/cm or less, for example, high resistance carbon black, metal oxides such as titanium oxide, complex oxide of copper-iron-manganese, complex oxide of copper-chromium-manganese, and the like can be listed as shading particles which can be used. As the resin component used, polyimide resins, acrylic resins, epoxy resins, and the like can be listed.

The thickness of the black matrix 13 as described above can be appropriately set, for example, in a range of 0.5 to 2.0 μm, and the amount of shading particles contained in the black matrix 13 can be appropriately set in a range of 30 to 60% by weight depending on the material used.

In the color filter 14 constituting the color filter substrate 11, a red pattern, a green pattern and a blue pattern are arranged in a desired pattern form, and can be formed by a pigment dispersion method using a photosensitive resin containing desired coloring materials, further, can be formed by known method such as a printing method, an electrodeposition method, a transferring method, a dyeing method and the like. When the color filter 14 is formed by any formation method, it is necessary to appropriately determine resin materials, pigments, dyes and the like used so that the electric conductivity of a coloring pattern of each color is 2.0×10⁻¹⁰ S/cm or less.

The thickness of such a color filter 14 can be appropriately set in a range of, for example, 1.0 to 3.0 μm. It may also be permissible that the optimum liquid crystal layer thickness (cell gap) is set for each color of the color filter 14, for example, by making a red pattern thinnest and allowing the thickness to increase in the order of a red pattern, a green pattern and a blue pattern.

The protective layer 15 constituting the color filter substrate 11 is provided to prevent elution of components contained in the color filter 14 into a liquid crystal layer. This protective layer 15 is formed using a resin material and contains no pigments and the like having high electric conductivity, therefore, an influence on an electric force line formed in between the common electrode 23 and the pixel electrode 27 can be ignore. The thickness of such a protective layer 15 can be set in view of the light transmittance of the material used, the surface condition of the color filter substrate 11, and the like, and for example, can be set in a range of 0.2 to 3.0 μm.

The common electrode 23, scanning wiring 24 and common wiring 25 constituting the electrode substrate 21 can be formed, for example, by forming a transparent conductive film such as indium tin oxide (ITO) and the like, or a metal conductive film by sputtering and the like, and etching this via a predetermined resist pattern.

The insulation layer 26 constituting the electrode substrate 21 can be formed by formation of a silicon nitride thin film by a CVD method or the like. Further, the semiconductor active layer 30 made of amorphous silicon a-Si can be formed by the same process as for this insulation layer 26.

The pixel electrode 27 and signal wiring 28 constituting the electrode substrate 21 can be formed, for example, by forming a metal conductive film or transparent conductive film such as ITO and the like by sputtering ad the like, and etching this via a predetermined resist pattern.

The protective layer 29 constituting the electrode substrate 21 is provided to flatten the surface of the electrode substrate 21. The thickness of such a protective layer 29 can be set in view of the light transmittance of the material used, the surface condition of the electrode substrate 21, and the like, and for example, can be set in a range of 0.2 to 3.0 μm.

### EXAMPLES

Next, the present invention will be explained further in detail by examples.

### Production of Color Filter Substrate

[Sample A]

A glass substrate (7059 glass manufactured by Corning) having a thickness of 0.7 mm was prepared as a substrate for a color filter substrate. This substrate was cleaned according to an ordinary method, then, a composition A for black matrix (BK760 series manufactured by Tokyo Ohka Kogyo Co., Ltd.) containing high resistance carbon black was applied on the whole surface of one side of the substrate, and exposed via a predetermined photomask, then, developed and calcined by heating to form a black matrix (thickness: 1.3 μm).

The electric conductivity of the above-mentioned black matrix was measured according the following conditions, and the results are shown in Table 1 below.

(Method of Measuring Electric Conductivity)

On a chromium thin film formed on a glass substrate, a film is formed in the same process as for formation of a color filter, using a material of measuring subject. On this film, a gold electrode is formed by a vapor deposition method, and electric conductivity is measured between this gold electrode and the above-mentioned chromium thin film using IMPEDANCE/GAIN-PHASE ANALYZER SI1260, DIELECTRIC INTERFACE 1296, manufactured by Solartron. Measurement is conducted at 3V sweeping from 1 Hz to 1 MHz. The measurement result at 1 kHz is used as electric conductivity.

The specific resistance ρ of the above-mentioned black matrix was measured under the following conditions, and the results are shown in Table 1 below.

(Method of Measuring Specific Resistance)

On a chromium thin film formed on a glass substrate, a film is formed as the same process as for formation of a color filter, using a material of measuring subject. This film is measured using Hiresta-UP (MCP-HT450) manufactured by Mitsubishi Chemical Co., Ltd.

Next, respective coating solutions for a red pattern, a green pattern and a blue pattern of the following compositions were prepared, and a red pattern, a green pattern and a blue pattern (thickness: 1.7 μm) were formed respectively in pixel regions according to a known pigment dispersion method using the solutions to form a color filter.

(Composition or red pattern coating solution)

| | |
|---|---|
| PR254 dispersion liquid | 33 parts by weight |
| Photosensitive resin composition I | 67 parts by weight |
| Propylene glycol monomethyl ether acetate | 400 parts by weight |

(Composition of green pattern coating solution)

| | |
|---|---|
| PG7/PG150 dispersion liquid | 31 parts by weight |
| Photosensitive resin composition I | 69 parts by weight |
| Propylene glycol monomethyl ether acetate | 400 parts by weight |

(Composition of blue pattern coating solution)

| | |
|---|---|
| PB15:6/PV23 dispersion liquid | 17 parts by weight |
| Photosensitive resin composition II | 83 parts by weight |
| Propylene glycol monomethyl ether acetate | 400 parts by weight |

The above-described photosensitive resin composition I and photosensitive resin composition II have respectively the following compositions, and they are the same also in the following examples.

(Photosenisitive resin composition I)

| | |
|---|---|
| Methacrylic acid-styrene-acrylic acid radical | 42 parts by weight |
| copolymer | |
| Dipentaerythrltol hexaacrylate | 32 parts by weight |
| Epicoat 180S70 (manufactured by Mitsubishi Yuka | 18 parts by weight |
| Shell K.K.) | |
| 2-benzyl-2-dimethylamino-1-(4-morpholinophenyl)- | 8 parts by weight |
| butanone-1 (manufactured by Chiba Speciality | |
| Chemicals) | |

(Photosensitive resin composition II)

| | |
|---|---|
| Methacrylic acid-styrene-acrylic acid radical | 42 parts by weight |
| copolymer | |
| Dipentaerythritol hexaacrylate | 32 parts by weight |
| Epolead GT401 (manufactured by Daicel Chemical | 18 parts by weight |
| Industries, Ltd.) | |
| 2-methyl-1-[4-(methylthio)phenyl]-2-morpholino- | 8 parts by weight |
| propane-1-one (manufactured by Chiba Speciality | |
| Chemicals) | |

Regarding the above-mentioned coloring patterns of respective colors, electric conductivity and specific resistance were measured in the same manner as described above, and the results are shown in Table 1 below.

Next, diluted liquid of a polyimide resin was applied on a substrate and dried to form a protective layer, further, on this protective layer, diluted liquid of a polyimide resin was applied and dried to form an alignment layer, producing a color filter substrate (sample A).

[Sample B]

A color filter substrate (sample B) was produced in the same manner as for the above-mentioned sample A except that a black matrix composition B of the following composition containing titanium black was used instead of the black matrix composition A containing high resistance carbon black.

(Black matrix composition B)

| | |
|---|---|
| Titanium black (13 M: manufactured by Mitsubishi | 61 parts by weight |
| Materials Corporation) | |
| Photosensitive resin composition I | 39 parts by weight |
| Methoxy butyl acetate | 300 parts by weight |

The electric conductivity and specific resistance of the above-mentioned black matrix were measured in the same manner as for the sample A and the results are shown in Table 1 below.

[Comparative Sample A]

A black matrix was formed on a glass substrate using the black matrix composition A in the same inner as for the above-mentioned sample A.

Next, respective coating solutions for a red pattern, a green pattern and a blue pattern of the following compositions were prepared, and a red pattern, a green pattern and a blue pattern (thickness: 1.7 μm) were formed respectively in pixel regions according to a known pigment dispersion method using the solutions to form a color filter.

(Composition of red pattern coating solution)

| | |
|---|---|
| PR254 dispersion liquid | 33 parts by weight |
| Photosensitive resin composition I | 67 parts by weight |
| Propylene glycol monomaethyl ether acetate | 400 parts by weight |

(Composition of green pattern coating solution)

| | |
|---|---|
| PG36/PY150 dispersion liquid | 32 parts by weight |
| Photosensitive resin composition I | 68 parts by weight |
| Propylene glycol monomethyl ether acetate | 400 parts by weight |

(Composition of blue pattern coating solution)

| | |
|---|---|
| PB315: 6/PV23 dispersion liquid | 17 parts by weight |
| Photosensitive resin composition II | 93 parts by weight |
| Propylene glycol monomethyl ether acetate | 400 parts by weight |

Regarding the above-mentioned coloring patterns of respective colors, electric conductivity and specific resistance were measured in the same manner as for the sample A, and the results are shown in Table 1 below.

Next, diluted liquid of a polyimide resin was applied on a substrate and dried to form a protective layer, further, on this protective layer, diluted liquid of a polyimide resin was applied and dried to form an alignment layer, and a color filter substrate (comparative sample A) is produced.

[Comparative Sample B]

A color filter substrate (comparative sample B) was produced in the same manner as for the above-mentioned comparative sample A except that the same black matrix composition B as used for production of the above-mentioned sample B was used.

[Comparative Sample C]

A color filter substrate (comparative sample C) was produced in the same manner as for the above-mentioned sample A except that a black matrix composition C (BK 450 series manufactured by Tokyo Ohka Kogyo Co., Ltd.) containing carbon black was used instead of the black matrix composition A containing high resistance carbon black.

The electric conductivity and specific resistance of the above-mentioned black matrix were measured in the same manner as for the sample A and the results are shown in Table 1 below.

### Production of Electrode Substrate

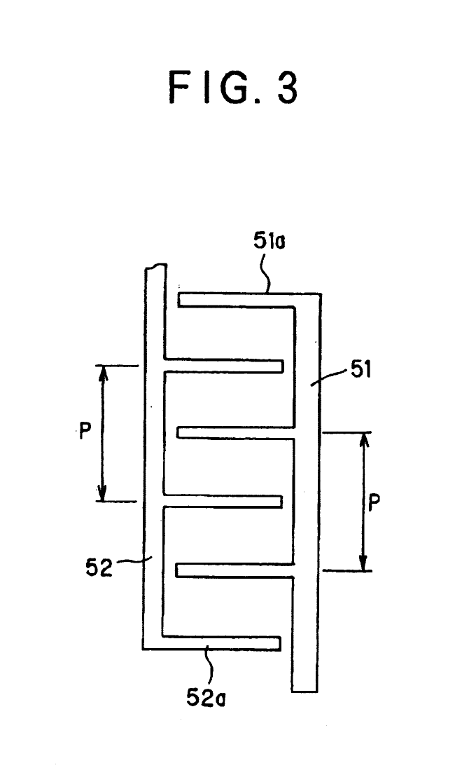

A glass substrate (7059 glass manufactured by Corning) having a thickness of 0.7 mm was prepared as a substrate for an electrode substrate. This substrate was cleaned according to an ordinary method, then, a thin film (thickness: 1000 Å) of indium tin oxide (ITO) was formed by sputtering, thereafter, patterning was performed to form an electrode pattern 51, 52 in the form of comb teeth as shown in FIG. 3. The interval P of each electrode 51a, 52a constituting this electrode pattern 51, 52 in the form of comb teeth was 100 μm.

Next, the diluted liquid of a polyimide resin was applied on a substrate and dried to form a protective layer, further, on this protective layer, diluted liquid of a polyimide resin was applied and dried to form an alignment layer, producing an electrode substrate.

### Evaluation

Regarding five combinations (samples 1 to 5) of each color filter substrates (sample A, sample B, comparative samples A to C) with the electrode substrates, produced as described above, liquid crystal cells were fabricated and a driving test was conducted.

### Evaluation Method

The presence or absence of color unevenness and a residual image was observed visually, and evaluated according to the following standard.

TABLE 1

| | Black matrix | | | |
|---|---|---|---|---|
| Color filter | Electric | Specific | Color filter | |
| substrate | conductivity | resistance | Electric conductivity (S/cm) | Specific resistance (Ω · cm) |

| Sample | used | (S/cm) | (Ω · cm) | Red | Green | Blue | Red | Green | blue | Evaluation |
|---|---|---|---|---|---|---|---|---|---|---|
| 1 | Sample A | 8.79 × 10⁻¹⁰ | 10¹⁰ | 4.02 × 10⁻¹¹ | 1.23 × 10⁻¹⁰ | 5.57 × 10⁻¹¹ | 10¹⁵ or | 10¹⁶ or | 10¹⁶ or | ◯ |
| 2 | Sample B | 2.66 × 10⁻¹⁰ | 10¹⁴ | | | | more | more | more | ◯ |
| 3 | Comparative | 8.79 × 10⁻¹⁰ | 10¹⁰ | 4.02 × 10⁻¹¹ | 3.03 × 10⁻¹⁰ | 5.57 × 10⁻¹¹ | 10¹⁵ or | 8.5 × 10¹⁵ | 10¹⁶ or | X |
| | Sample A | | | | | | more | | more | |
| 4 | Comparative | 2.66 × 10⁻¹⁰ | 10¹⁴ | | | | | | | X |
| | Sample B | | | | | | | | | |
| 5 | Comparative | 1.75 × 10 ⁻⁷ | 10⁶ | 4.02 × 10⁻¹¹ | 1.23 × 10⁻¹⁰ | 5.57 × 10⁻¹¹ | 10¹⁶ or | 10¹⁶ or | 10¹⁵ or | X |
| | Sample C | | | | | | more | more | more | |

(Evaluation standard)
◯: Color unevenness and a residual image are not found
X: Color unevenness and a residual image are found

As shown in Table 1, it was confirmed that, when the color filter substrates (samaple A, sample B) in which the black matrix has an electric conductivity of 9.0×10⁻⁹ S/cm or less and the color filter has an electric conductivity of 2.0×10⁻¹⁰ S/cm or less are used (sample 1, sample 2), transverse electric field becomes stable, and by using these color filter substrates, a liquid crystal display is obtained which the reverse twist of liquid crystal molecules is prevented and having excellent displayed image quality.

In contrast, when the color filter substrates (comparative sample A, comparative sample B) in which the black matrix has an electric conductivity of 9.0×10⁻⁹ S/cm or less (the specific resistance is 10⁶ Ω·cm or more) but the color filter has an electric conductivity of over 2.0×10⁻¹⁰ S/cm were used (sample 3, sample 4), the stability of transverse electric field was insufficient.

Further, also when the color filter substrate (comparative sample C) in which the color filter has an electric conductivity of 2.0×10⁻¹⁰ S/cm or less but the black matrix has an electric conductivity of over 9.0×10⁻⁹ S/cm was used (sample 5), the stability of transverse electric field was insufficient.

What is claimed is:

1. A liquid crystal display comprising a color filter substrate having a black matrix, a color filter composed of coloring patterns of a plurality of colors and a protective layer formed to cover said black matrix and color filter, an electrode substrate having a pixel electrode and a common electrode provided parallel to the substrate surface, and a liquid crystal layer formed by sandwiching a liquid crystal substance in between said electrode substrate and said color filter substrate, wherein the black matrix has an electric conductivity of 9.0×10⁻⁹ S/cm or less and the coloring pattern has an electric conductivity of 2.0×10⁻¹⁰ S/cm or less.

2. The liquid crystal display according to claim 1, wherein said black matrix comprises either high resistance carbon black or titanium oxide in a resin component.
